(19) United States
(12) Patent Application Publication
(10) Pub. No.: US 2006/0163153 A1
(43) Pub. Date: Jul. 27, 2006

(54) Hydrocyclone

(76) Inventor: Sven Lennart Caldelman, Taby (SE)

Correspondence Address: YOUNG & THOMPSON, 745 SOUTH 23RD STREET, 2ND FLOOR, ARLINGTON, VA, 22202, US

(21) Appl. No.: 10/515,321

(22) PCT Filed: May 26, 2003
(86) PCT No.: PCT/SE03/00850

§ 371 Date: Jul. 25, 2005

(30) Foreign Application Priority Data
May 27, 2002 (SE) 0201579-0

(51) Int. Cl. B01D 21/26

(52) U.S. Cl. 210/512.1; 209/725; 209/730

(57) ABSTRACT

A hydrocyclone for separating a fibre suspension into a heavy fraction substantially containing heavy contaminants and a light fibre fraction substantially containing fibres includes an elongated separation chamber with two opposite ends, a first outlet member for discharging the light fraction at one end, and a second outlet member for discharging the heavy fraction at another end. A distribution head for supplying fluid to the separation chamber is centrally situated relatively close to the other end and has at least one outlet passage for spraying a fluid jet in a direction obliquely against the circumferential wall of the separation chamber, as seen in a projection of the fluid jet on a plane extending perpendicular to the center axis of the separation chamber.

The present invention relates to a hydrocyclone for separating a fibre suspension into a heavy fraction substantially containing heavy contaminants and a light fibre fraction substantially containing fibres, comprising a housing with a circumferential wall defining an elongated separation chamber with two opposite ends and with a cenre axis extending between the opposite ends. The hydrocyclone further comprises an inlet member for supplying the fibre suspension substantially tangentially into the separation chamber at one end thereof, so that the fibre suspension flows in a vortex in the separation chamber, a first outlet member for discharging the light fibre fraction from the separation chamber at said one end, and a second outlet member for discharging the heavy fraction from the separation chamber at the other end thereof, and a distribution head for supplying a fluid to the separation chamber. The distribution head is situated centrally in the separation chamber relatively close to said second end and has at least one outlet passage designed for spraying a fluid jet a direction towards the circumferential wall of the separation chamber. The outlet passage is designed for spraying the fluid jet in a direction obliquely towards the circumferential wall of the separation chamber, as seen in a projection of the fluid jet on a plane extending perpendicular to the centre axis of the separation chamber.

A well-known problem that might arise during operation of hydrocyclones of this kind is that the heavy fraction, which typically has a substantially smaller flow than the light fibre fraction, thickens heavily and as a result might tend to clog the second outlet member. The fluid supply device aims at eliminating this problem by supplying the fluid in the form of liquid to the separation chamber in order to dilute the thickening heavy fraction. There are different known fluid supply devices, which have in common that the liquid is supplied to the separation chamber through a liquid channel through the circumferential wall of the separation chamber.

However, another problem arises in connection with using such a known fluid supply device, namely that the separation efficiency of the hydrocyclone is deteriorated. Thus, the fluid supply device causes more relatively heavy particles to leave the hydrocyclone along with the light fibre fraction, which is a serious drawback. Besides preventing clogging of the outlet for heavy fractions by the known fluid supply device it is true that also the advantage may be obtained that some fibres that otherwise would have been lost with the heavy fraction can follow the light fibre fraction. This advantage, however, is obtained at the expense of deteriorated separation efficiency, i.e. that heavy contamination particles follow the light fibre fraction, which in many cases is an unacceptable drawback. For these reasons hydrocyclones with such fluid supply devices have not been used to any greater extent within the paper pulp industry.

The object of the present invention is to provide an improved hydrocyclone of the kind described above, which can be operated with a satisfying separation efficiency and which in addition is suited for separating contaminated fibre suspensions without initiating the above described drawbacks of known hydrocyclones.

This object is obtained by a hydrocyclone of the kind initially described characterized in that the outlet passage is designed such that the fluid jet sprayed from it has a flow component in the direction towards the other end of the separation chamber.

Hereby clogging of the outlet for heavy fraction is efficiently counteracted without deteriorating the separation efficiency with respect to heavy particles. The main reason for this positive action of the hydrocyclone according to the invention is that the fluid jet is sprayed in the direction outwardly from the central part of the separation chamber, whereby heavy particles are not entrained by the fluid jet into the central portion of the separation chamber where the heavy particles run the risk of being pulled with the central flow of the developed light fraction. In addition, it has surprisingly been proved that the separation efficiency with respect to separation of heavy contaminants from fibre suspensions not only is substantially improved by the hydrocyclone according to the invention as compared to the separation efficiency of known hydrocyclones equipped with fluid supply devices of the kind here present but in addition is significantly improved as compared to the separation efficiency of traditional hydrocyclones that lack such fluid supply devices.

The circumferential wall of the separation chamber is advantageously provided with at least one helical channel for transportation of separated heavy particles towards the other end of the separation chamber, a distribution head being arranged to spray fluid jets against the helical channel. This results in that the transportation of the separated heavy particles is facilitated.

The outlet passage is suitably designed for spraying the fluid jet in a direction that forms an angle of maximally 30° to the normal toward the circumferential wall where the fluid jet hits the circumferential wall.

The outlet passage may advantageously be designed such that the fluid jet sprayed from it has a flow component in the rotational direction of the vortex of the fibre suspension.

The hydrocyclone according to the invention may comprise a third outlet member for discharging a separated further light fraction substantially containing light contaminants centrally from the separation chamber at said one end, the further light fraction being lighter than the light fibre fraction. In this case the fluid supply device may advantageously supply gas, suitably air, so that an air jet is sprayed against the circumferential wall of the separation chamber. Besides counteracting clogging of the outlet member for heavy fraction the supplied air will separate to the central part of the separation chamber and there pull light contaminants in the direction towards the third outlet member, so that also the separation efficiency with respect to light contaminants is improved.

According to a preferred embodiment of the invention the distribution head comprises a cylindrical wall with two axial ends and a gable wall covering one end of the cylindrical wall, the outlet passage being formed by a bore extending obliquely through the cylindrical wall. Alternatively, the distribution head may comprise a conical wall, the outlet passage being formed by a bore in the conical wall. Of course, the distribution head may comprise a plurality of outlet passages, for example three, which are evenly distributed around the cylindrical or conical wall. The fluid supply device suitably comprises a supply pipe, which extends through said other end of the separation chamber centrally into the separation chamber and which is joined to the distribution head, the interior of the supply pipe communicating with the outlet passage of the distribution head.

In a conventional manner the separation chamber normally has a conical chamber section with an apex end corresponding to said other end of the separation chamber. The distribution head should be situated in said conical chamber section, preferably so that the outlet passage of the distribution head opens in the conical chamber section at a distance from the apex end, which is 0 till 45%, preferably 3-15%, of the axial length of the conical chamber section. Furthermore, the radial extension of the annular passage defined by the distribution head and the circumferential wall of the conical chamber section of the separation chamber preferably is 6 to 60% of the radius in the conical chamber section axially in front of the distribution head.

The invention is described in more detail in the following with reference to the accompanying drawing, in which

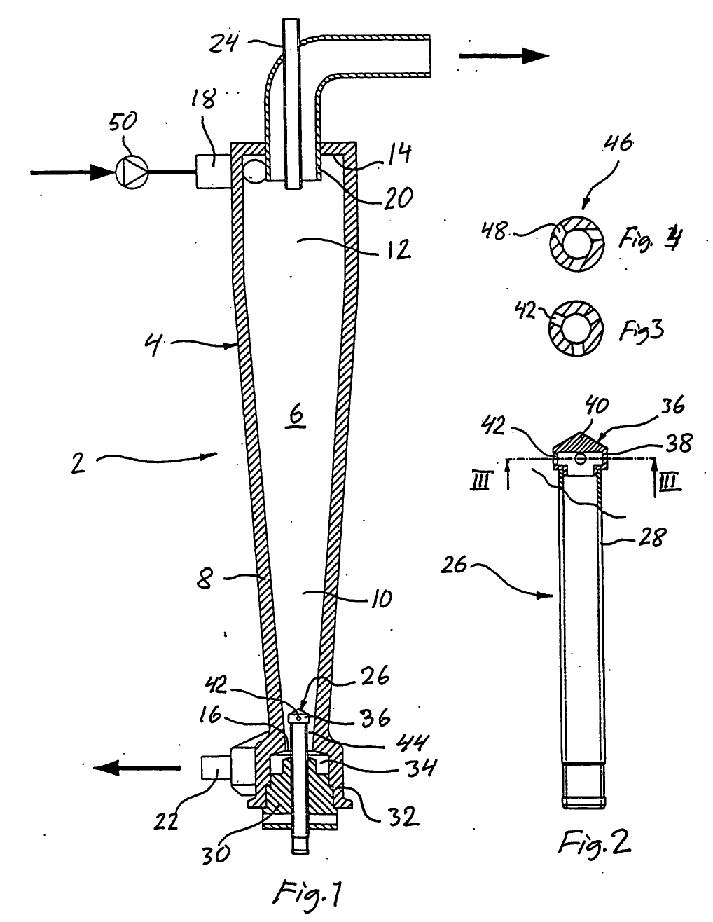

FIG. 1 shows a view of an axial cross-section through a hydrocyclone according to an embodiment of the invention,

FIG. 2 shows an enlarged fluid supply device in the hydrocyclone according to FIG. 1,

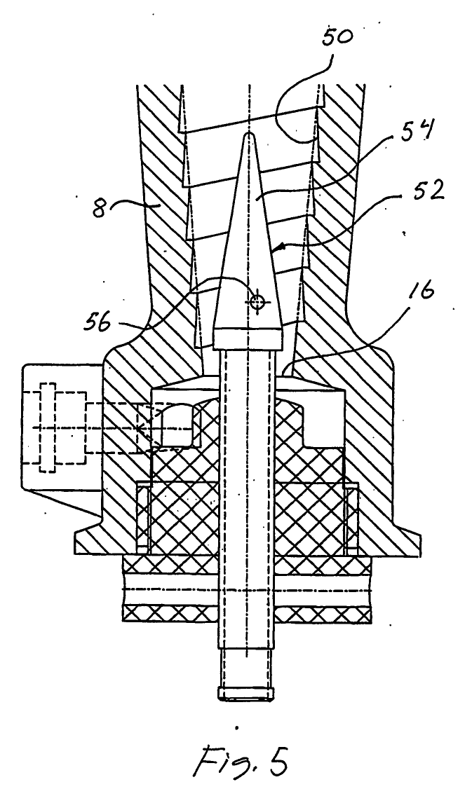

FIG. 3 shows a cross-section along the line III-III in FIG. 2,

FIG. 4 shows a modification of the embodiment according to FIG. 3, and

FIG. 5 shows an axial cross-sectional view through the hydrocyclone according to another embodiment of the invention.

In the Figures the same components in the embodiments shown are provided with the same reference numerals.

In FIG. 1 there is shown an example of a hydrocyclone 2 according to the invention specially dimensioned for separating a fibre suspension containing relatively light and heavy contaminants. The hydrocyclone 2 comprises a housing 4, which forms a separation chamber 6, which is 49 cm in length, with a circumferential wall 8. The separation chamber 6 has a conical chamber section 10, the length of which is about 28 cm, and a cylindrical chamber section 12 connecting the base of the conical chamber section 10, whereby the separation chamber 6 has a relatively broad base end 14 and an opposite relatively narrow open apex end 16. In this example the cone angle of the conical chamber section 10 is 10°. In general, however, said cone angle may be in the range of 5-20°. The separation chamber 6 has a centre axis 17 extending between the base end 14 and the apex end 16.

There is an inlet member 18 for supplying the fibre suspension tangentiallly into the cylindrical chamber section 12 at the base end 14 of the separation chamber. A first outlet member in the form of a pipe 20 extends centrally a distance into the cylindrical chamber section 12 from the base end 14 of the separation chamber 6 for discharging a light fraction of fibre suspension substantially containing fibres. A second outlet member 22 is arranged at the apex end 16 of the separation chamber 6 for discharging a heavy fraction of the fibre suspension containing heavy contamination particles, such as sand, metal fragments and the like. A third outlet member in the form of a pipe 24 having a substantially smaller diameter than the pipe 20 extends centrally through the pipe 20 for discharging a further light fraction of the fibre suspension containing light contamination particles, such as plastic fragments and the like.

The hydrocyclone 1 further comprises a fluid supply device 26 for supplying liquid and/or gas to the conical chamber section 10 of the separation chamber 6 relatively close to the apex end 16. The fluid supply device 26 comprises a supply pipe 28 attached to a cylindrical plug 30. The circumferential wall 8 passes from the apex end 16 to a radially expanded portion 32 of the housing 4, which defines an open cylindrical chamber 34, which is closed by the plug 30, for example through threads, so that the supply pipe 28 extends centrally into the conical chamber section 10 via the apex end 16. The end of the supply pipe 28 in the separation chamber 6 is closed by a distribution head 36, which comprises a cylindrical wall 38 with two axial ends and a gable wall 40 covering one end of the wall 38, see FIG. 2. The wall 38 is provided with three radial bores forming outlet passages 42, which communicate with the interior of the supply pipe 28, see FIG. 3. In this case, each outlet passage 42 opens in the conical chamber section 10 about 4 cm from the apex end 16. The distribution head 36 and the circumferential wall 8 of the conical chamber section 10 define an annular passage 44 for developed heavy fraction, the passage 44 having a radial extension of about 0.5 cm.

In general, each outlet passage 42 should open at a distance from the apex end 16 which is 5 to 45% of the axial length of the conical chamber section 10, and the radial extension of the passage 44 should be 6 to 60% of the radius in the conical chamber section 10 in front of the distribution head 36. Suitable values from these ranges are to be determined empirically in each and every case.

In FIG. 4 there is shown a distribution head 46 according to an alternative embodiment, which is equivalent to the distribution head 36 except that it has three outlet passages 48 designed differently. Thus, the outlet passages 48 extend non-radially through the cylindrical circumferential wall of the distribution head 46, as seen in a cross-section there through.

FIG. 5 shows a hydrocyclone according to another embodiment of the invention, in which the circumferential wall 8 of the separation chamber 6 is provided with at least one helical channel 50 for transporting separated heavy particles towards the other end 16 of the separation chamber. The channel 50 extends in the same direction as the rotating swirl in the separation chamber 6. In this case the fluid supply device has a distribution head 52, which is designed with a conical wall 54, each outlet passage being formed by a bore 56 in the conical wall 54. The distribution head 52 is arranged to spray fluid jets against at least a part of the helical channel 50. The channel 50 may be designed in many ways, for example with the shape of a trapezoidal thread or with a triangular cross-section as shown in FIG. 5.

During operation of the hydrocyclone 1 according to FIG. 1 the fibre suspension, which contains relatively light and heavy contaminants, is pumped by a pump 50 tangentially into the separation chamber 6 via the inlet member 18, so that a vortex of the fibre suspension is created in the separation chamber 6. As a result, the fibre suspension separates into a light fibre fraction substantially containing fibres, which are discharged through the pipe 20, a further light fraction containing relatively light contaminants, which are discharged through the pipe 24, and a heavy fraction containing relatively heavy contaminants, which are discharged through the outlet member 22. A mixture of water and air is sprayed by the fluid supply device 26 against the circumferential wall 8 of the conical chamber section 10 to dilute the developed thick heavy fraction and release embedded fibres, so that these may follow the developed light fibre fraction. The injected air separates in the form of bubbles inwardly in the separation chamber 6 and entrains light contaminants to the centrally situated pipe 24.

Of course, as an alternative the fluid supply device 26 may only supply liquid or gas to the separation chamber 6.

In any of the above-described embodiments the circumferential of the separation chamber may be provided with the helical channel or, alternatively, be designed with a smooth surface.

1. A hydrocyclone (2) for separating a fibre suspension into a heavy fraction substantially containing heavy contaminants and a light fibre fraction substantially containing fibres, comprising a housing (4) with a circumferential wall (8), which defines an elongated separation chamber (6) with two opposite ends (14,16) and with a cenre axis (17) extending between the opposite ends, an inlet member (18) for supplying the fibre suspension substantially tangentially into the separation chamber at one end (14) thereof, so that the fibre suspension flows in a vortex in the separation chamber, a first outlet member (20) for discharging the light fraction from the separation chamber at said one end, a second outlet member (22) for discharging the heavy fraction from the separation chamber at the other end (16) thereof, and a distribution head (36; 46; 52) for supplying a fluid to the separation chamber, which distribution head is situated centrally in the separation chamber (6) relatively close to said other end (16) and having at least one outlet passage (42; 48; 56) designed for spraying a fluid jet in a direction towards the circumferential wall (8) of the separation chamber (6), the outlet passage (48) being designed for spraying the fluid jet in a direction obliquely against the circumferential wall (8) of the separation chamber (6), as seen in a projection of the fluid jet on a plane extending perpendicular to the cenre axis (17) of the separation chamber, characterized in that the outlet passage (48) is designed such that the fluid jet that is sprayed from it has a flow component in the direction towards the other end (16) of the separation chamber (6).

2. A hydrocyclone according to claim 1, characterized in that the circumferential wall (8) of the separation chamber is provided with at least one helical channel (50) for transporting separated heavy particles towards the other end (16) of the separation chamber, the distribution head (36; 46; 52) being arranged to spray fluid jets against the helical channel.

3. A hydrocyclone according to claim 1 characterized in that the outlet passage (48) is designed such that the fluid jet that is sprayed from it has a flow component in the rotational direction of the vortex of the fibre suspension.

4. A hydrocyclone according to claim 1, characterized in that the outlet passage (48) is designed for spraying the fluid jet in a direction that forms an angle of maximally 30° to the normal to the circumferential wall where the fluid jet hits the circumferential wall.

5. A hydrocyclone according to claim 1, characterized in that the distribution head (36) comprises a cylindrical wall(38) with two axial ends and a gable wall (40) covering one end of the cylindrical wall, the outlet passage (48) being formed by a bore extending obliquely through the cylindrical wall.

6. A hydrocyclone according to claim 1, characterized in that the fluid supply device (26) comprises a supply pipe (28), which extends through said other end (16) of the separation chamber (6) centrally into the separation chamber and which is joined to the distribution head(36; 46; 52), the interior of the supply pipe communicating with the outlet passage(42; 48; 56) of the distribution head.

7. A hydrocyclone according to claim 1, in which the separation chamber (6) has a conical chamber section (10) with an apex end (16) corresponding to said other end of the separation chamber, characterized in that the distribution head (36; 46; 52) is situated in the conical chamber section (10) of the separation chamber.

8. A hydrocyclone according to claim 7, characterized in that the outlet passage (42;48; 6) of the distribution head (36; 46; 52) opens into the conical chamber section (10) of the separation chamber (6) at a distance from the apex end (16) which is 0 to 45%, preferably 3-15%, of the axial length of the conical chamber section.

9. A hydrocyclone according to claim 7, characterized in that the distribution head (36; 46; 52) and the circumferential wall (8) of the conical chamber section (10) of the separation chamber (6) define an annular passage (44), the radial extension of which is 6 to 60% of the radius in the conical chamber section axially in front of the distribution head.

10. A hydrocyclone according to claim 1, characterized in that it comprises a third outlet member (24) for discharging a further separated light fraction substantially containing light contaminants centrally from the separation chamber (6) at said one end (14), the further light fraction being lighter than the light fibre fraction.

11. A hydrocyclone according to claim 1, characterized in that the fluid supply device (26) is adapted to supply fluid in the form of liquid or gas.

12. A hydrocyclone according to claim 2, characterized in that the outlet passage (48) is designed such that the fluid jet that is sprayed from it has a flow component in the rotational direction of the vortex of the fibre suspension.

13. A hydrocyclone according to claim 8, characterized in that the distribution head (36; 46; 52) and the circumferential wall (8) of the conical chamber section (10) of the separation chamber (6) define an annular passage (44), the radial extension of which is 6 to 60% of the radius in the conical chamber section axially in front of the distribution head.
